(19) United States
(12) Patent Application Publication
(10) Pub. No.: US 2026/0219364 A1
(43) Pub. Date: Jul. 30, 2026

(54) Method and Apparatus for Providing Data for Monitoring a Vehicle Interior

(71) Applicant: Bayerische Motoren Werke Aktiengesellschaft, Muenchen (DE)

(72) Inventor: Marjan Buzanin, Muenchen (DE)

(21) Appl. No.: 19/147,584

(22) PCT Filed: Oct. 13, 2023
(86) PCT No.: PCT/EP2023/078503

§ 371 Date: Jul. 11, 2025

(30) Foreign Application Priority Data
Jan. 20, 2023 (DE) 10 2023 101 419.6

(51) Int. Cl. G01S 7/41; G01S 13/88

(52) U.S. Cl. CPC G01S 7/417; G01S 13/88

(57) ABSTRACT

A method for providing data for monitoring a vehicle interior includes a step of obtaining first data. The first data represents raw data from a radar sensor. The raw data relates to the vehicle interior and has a first dimensionality. The method further includes performing a dimensionality reduction process on the first data in order to generate second data. The second data has a second dimensionality, which is lower in comparison with the first data. The method also includes providing the second data for a vehicle bus.

The present application is the U.S. national phase of PCT Application PCT/EP2023/078503 filed on Oct. 13, 2023, which claims priority of German patent application No. 10 2023 101 419.6 filed on Jan. 20, 2023, the entire contents of which are incorporated herein by reference.

### TECHNICAL FIELD

The present disclosure relates generally to the field of vehicles, and more particularly to providing data for monitoring a vehicle interior and to monitoring a vehicle interior.

### BACKGROUND

A radar sensor can be used in a vehicle to detect the vehicle interior. For example, it can be used to detect people or vehicle occupants, events in the vehicle interior, or the like. A high degree of movement, frequencies and the like can occur during the detection of the vehicle interior, however, with the result that the sensor data from the radar sensor can attain a correspondingly high data volume. For further processing of the sensor data it would be conceivable to provide the sensor data for a control means, for instance a control unit, of the vehicle, for which purpose the sensor data could be sent to the control means via a vehicle bus, for example. In this case, however, the high data volume of the sensor data would cause a high bus load on the vehicle bus.

Therefore, there is a need to provide a facility for monitoring a vehicle interior using a radar sensor.

### SUMMARY

At least some embodiments disclosed here address the above-stated need, as well as others.

Exemplary embodiments concern a method for providing data for monitoring a vehicle interior. The method comprises obtaining first data, which represents, comprises, or the like raw data from a radar sensor, which raw data relates to the vehicle interior and has a first dimensionality. In addition, the method comprises performing a dimensionality reduction process on the first data in order to generate second data, which has a second dimensionality, which is lower in comparison with the first data. The method further comprises providing the second data for a vehicle bus.

In some embodiments, a method allows the raw data from the radar sensor to be conditioned in order to reduce the data volume even before the associated data is transferred. In particular, the second data, which has a compressed data volume compared with the first data, generates a lower bus load on the vehicle bus than the first data or raw data from the radar sensor. Moreover, the second data is suitable as an input signal for a classifier, a machine learning algorithm, a neural network, or the like, because the dimensionality reduction process makes the first data clearer, for instance by efficiently condensing information contained in the first data. In addition, the dimensionality reduction process can also identify and/or select in an automated manner features that are helpful for the information content of the first data or relevant to the monitoring of the vehicle interior, or can focus the second data on helpful or relevant features, so that the second data is well suited as an input signal for a classifier, a machine learning algorithm, a neural network, or the like.

As used herein, the radar sensor can be any type of radio-based sensor that emits signals and receives the echoes reflected from objects as corresponding signals, and, for example, detects, localizes, etc. objects therefrom. For example, the radar sensor can be an ultra-wideband (UWB) sensor configured for radar operation. The radar sensor can also be configured to detect vital signs, for instance breathing etc., of vehicle occupants. The radar sensor can be arranged in the vehicle interior. A plurality of radar sensors for monitoring the vehicle interior can also be provided.

The dimensionality reduction process can be any type of mathematical, statistical etc. process, method or technique for dimensionality reduction and/or selection of relevant features that is suitable for reducing the data volume of the first data without losing too much information or rather preserving a sufficient information content and/or retaining relevant information. The dimensionality reduction thus reduces the dimensionality of the (first) data, and hence also its data volume, while retaining relevant information. Suitable for this purpose is any process, method or technique that reduces in associated data the set of features to a smaller set either of the original features or of new features or the like, wherein the new features can be linear or non-linear combinations and/or functions of the original features. Hence, for instance, the dimensionality reduction process can comprise and/or apply principal component analysis (PCA), wherein alternatively or additionally can also be comprised and/or applied factor analysis, canonical correlation analysis, correspondence analysis, multidimensional scaling, random forest, or the like, or a combination thereof. The first and second dimensionality can also be understood to be a first and second data volume, where the second data volume is smaller than the first data volume. The smaller second data accordingly causes a lower bus load than the first data.

The vehicle bus can be any type of bus system, for instance CAN, LIN, FlexRay, MOST, or the like. The second data can be provided via a suitable bus interface for the vehicle bus.

The method can be executed by any processor, for example a digital signal processor etc., computer, control unit, etc. of the vehicle. In addition, the method can be implemented in hardware, software, or a combination thereof.

In some exemplary embodiments, the dimensionality reduction process can reduce a set of first features in the first data and/or combine one or more first features into a set of second features, and generate the second data on the basis of the reduced set of first features and/or the set of second features. In other words, the dimensionality reduction process can, in an automated manner, combine relevant features and/or reduce the first data to said relevant features, i.e. expressed in yet another way, generate a feature set that is useful for the further processing of the sensor data.

In some exemplary embodiments, the dimensionality reduction process can identify and modify a number of amplitude-related signal features and/or phase-related signal features in the first data, and generate the second data on the basis thereof. Such signal features in the raw data from the radar sensor, i.e. the first data, allow the vehicle interior to be monitored precisely with at the same time a relatively low data volume.

In some exemplary embodiments, the dimensionality reduction process can comprise principal component analysis, PCA. It has been found that although the other above-mentioned processes, methods or techniques for dimensionality reduction can also be applied, principal component analysis has particularly good attributes as regards the data volume of the second data and the information content available therefrom for the further processing of the sensor data.

In some exemplary embodiments, the second data can comprise information on, or from, the first data, selected from: mean, variance, kurtosis, skewness, maximum value, minimum value, coefficient of variation, range, value of the arg max operator, standard deviation, peak location, peak magnitude, peak phase, peak shape, peak width, zero crossing rate, FFT maximum amplitude, FFT maximum frequency, entropy of the spectral power density, spectral flatness, autocorrelation width, autocorrelation peaks, sine frequency, sine amplitude, sine R\hat{ }2, main velocity, main velocity magnitude, velocity center of gravity, velocity curvature, velocity skewness, time difference of arrival, phase difference of arrival, and angle of arrival. This information facilitates good monitoring of the vehicle interior with a low data volume or low bus load.

It should be noted that the dimensionality reduction process or the generating of the second data can not only reduce the raw data from the radar sensor to relevant features, but the method can also comprise automated selection of the most relevant information, features, etc., where this selection can be made specifically for a particular interior scene to be captured.

In some exemplary embodiments, the second data can be set up or configured for processing by a monitoring process using a classifier, by a machine learning algorithm or the like, which is trained on the basis of training data that has the second dimensionality. For example, the classifier, machine learning algorithm, etc. can receive via the vehicle bus the second data, which it can use as an input signal, and evaluate or process further on the basis of its training.

Exemplary embodiments concern also a method for monitoring a vehicle interior. The method comprises providing second data according to the method described above for providing data for monitoring a vehicle interior. In addition, the method comprises receiving the second data via the vehicle bus. The method further comprises performing a monitoring process for the vehicle interior on the basis of the second data.

As described above, the method facilitates highly accurate detection and/or monitoring of the vehicle interior, people or vehicle occupants located therein, their vital signs, etc. while causing a minimum possible bus load on the vehicle bus.

In some exemplary embodiments, the monitoring process can apply a classifier, machine learning algorithm, or the like, which is trained on the basis of training data that has the second dimensionality. For example, the algorithm applied in the monitoring process can be trained on the basis of real or simulated training data that is similar to the second data, for instance has a similar or identical data structure, similar or identical features or feature set, etc. This allows precise detection or monitoring of the vehicle interior.

In some exemplary embodiments, the classifier, machine learning algorithm, or the like can be trained to detect objects, people or vehicle occupants and/or attributes relating to objects or people or vehicle occupants in the vehicle interior on the basis of the second data. For example, the applied algorithm can detect or evaluate the presence of people or vehicle occupants and/or their vital signs or the like.

Exemplary embodiments also concern a device for providing data for monitoring a vehicle interior. The device has at least one data interface, which is configured to obtain first data, wherein the first data represents, comprises, or the like raw data from a radar sensor, which raw data relates to the vehicle interior and has a first dimensionality. In addition, the device has processing logic, which is configured to perform a dimensionality reduction process on the first data in order to generate second data, which has a second dimensionality, which is lower in comparison with the first data. The at least one data interface is additionally configured to provide the second data for a vehicle bus.

The device in some embodiments is essentially configured to execute the above-described method, and therefore the device can be developed further correspondingly in accordance with the method described herein. The device facilitates precise detection or monitoring of the vehicle interior with at the same time a low bus load on the vehicle bus.

The device can be separate or can form with the radar sensor a common modular unit and/or be integrated therein. The processing logic can be any type of processor or data processor or the like. The data interface can be any type of input circuit or the like, via which the sensor data, i.e. the first data, can be obtained as raw data. The same or a further data interface can additionally have a vehicle bus module, for instance a CAN module, a LIN module, or the like, via which the device can be coupled to the vehicle bus.

Exemplary embodiments also concern a system for monitoring a vehicle interior. The system has the above-described device and a control means, which is configured to receive the second data via the vehicle bus, and to perform on the basis of the second data a monitoring process for the vehicle interior. The control means can be configured, for example, to detect objects, people or vehicle occupants, their vital signs, etc. i.e. to monitor the vehicle interior.

The system facilitates the evaluation of sensor data from a radar sensor with a low bus load on the vehicle bus and also precise detection or monitoring of the vehicle interior.

The control means can be, for example, a control unit of the vehicle and accordingly have a vehicle bus module, for instance a CAN module, a LIN module, or the like, in order to obtain or receive the second data. In addition, the control means can have processing logic, a processor, or the like, and be configured to receive the second data and to evaluate it for the purpose of monitoring the vehicle interior.

In some exemplary embodiments, the control means can have for the purpose of performing the monitoring process a classifier, machine learning algorithm, or the like, selected from: support vector machine, SVM, perceptron, multi-layer perceptron, MLP, and convolutional neural network. For example, the classifier can be trained on the basis of real or simulated training data that is similar to the second data, for instance has a similar or identical data structure, similar or identical features or feature set, etc. This allows precise detection or monitoring of the vehicle interior.

In some exemplary embodiments, the control means can additionally be configured to control at least one vehicle function based on the monitoring process. The vehicle function can be any type of function for which the vehicle interior is to be monitored. For example, the vehicle functions can be the access to the vehicle, the door opening and door closing, the air conditioning of the vehicle interior, a vehicle alarm system, or the like. Also by way of example, the monitoring process or the at least one vehicle can functions comprise driver monitoring, detection of children, dogs, or the like left in the vehicle, wherein the detection of left children, dogs, etc. can be intended to avoid critical situations in the heated vehicle interior, and can comprise a suitable alarm for the person responsible for the vehicle or vehicle owner, activation of the air conditioning, opening of vehicle windows, etc.

Exemplary embodiments also concern a computer program. This comprises commands which, on execution of the program by a processor, computer, processing logic, or the like, cause this to execute the method for providing data for monitoring a vehicle interior and/or the method for monitoring a vehicle interior, and/or to implement the device for providing data for monitoring a vehicle interior.

The above-discussed features and advantages, as well as others, will become more readily apparent to those of ordinary skill in the art by reference to the following detailed description and accompanying drawings.

### BRIEF DESCRIPTION OF THE DRAWINGS

FIG. 1 shows in a schematic block diagram a device for providing data for monitoring a vehicle interior according to an exemplary embodiment;

FIG. 2 shows in a schematic side view a vehicle that has a device for providing data for monitoring a vehicle interior or has a system for monitoring a vehicle interior according to an exemplary embodiment; and

FIG. 3 shows in a flow diagram a method for providing data for monitoring a vehicle interior according to an exemplary embodiment.

FIG. 4 shows in a flow diagram a method for monitoring a vehicle interior according to an exemplary embodiment.

### DETAILED DESCRIPTION

Various exemplary embodiments are now described in greater detail with reference to the accompanying drawings, which show some exemplary embodiments. In the figures, the thickness dimensions of lines, layers and/or regions may be exaggerated for the sake of clarity.

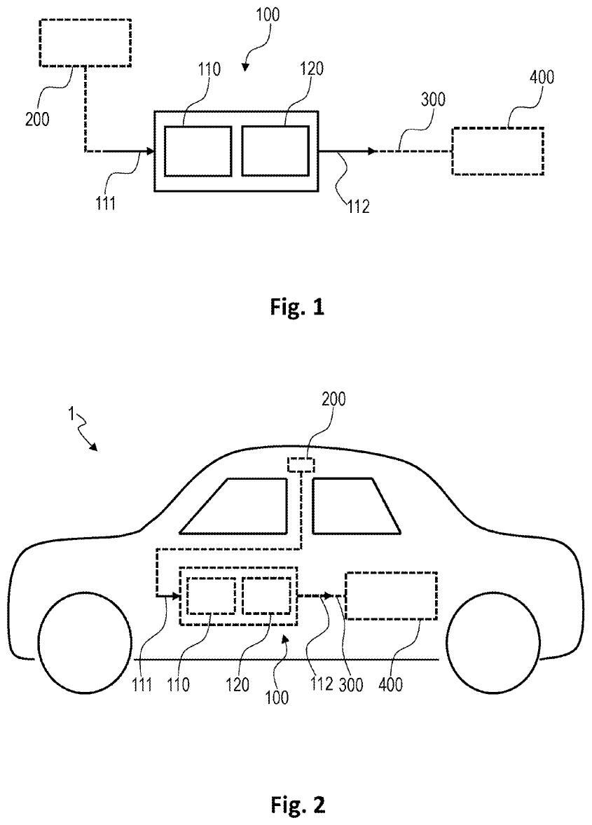

FIG. 1 illustrates in a schematic block diagram a device 100 for providing data for monitoring a vehicle interior. The device 100 is installed in a vehicle 1 (see FIG. 2) and coupled to at least one radar sensor 200 and a vehicle bus 300, with a control means 400 also coupled to the vehicle bus 300.

The device 100 has at least one data interface 110 and processing logic 120. The at least one data interface 110 is configured to obtain first data 111, wherein the first data 111 represents, contains, etc. raw data from the at least one radar sensor 200, which raw data relates to the vehicle interior and has a first dimensionality. The raw data from the wheel sensor 200 has high dimensionality because of its information content and therefore attains an enormous data volume. The processing logic 120 is configured to perform a dimensionality reduction process on the first data 111 in order to generate second data 112, which second data 112 has a second dimensionality, which is lower in comparison with the first data 111. The dimensionality reduction process is configured to reduce the dimensionality of the first data 111 while retaining relevant information. In addition, the at least one data interface 110 is also configured to provide the second data 112 for the vehicle bus 300 or to transfer it via the vehicle bus 300.

The device 100 can be separate or can form with the radar sensor 200 a common modular unit and/or be integrated therein. The processing logic 120 can be any type of processor or data processor or the like. The data interface 110 can be any type of input circuit, communication module, or the like, via which the sensor data, i.e. the first data 111, can be obtained or received as raw data. If the device 100 forms with the radar sensor 200 a common modular unit, the first data 111 can be received, for example, via conductor tracks, a circuit, etc. If, on the other hand, the device 100 is separate from the radar sensor 200, these can be wired together. The same or a further data interface 110 can additionally have a vehicle bus module, for instance a CAN module, a LIN module, or the like, via which the device 100 can be coupled to the vehicle bus 300.

In some exemplary embodiments, the dimensionality reduction process performed by the processing logic 120 can reduce a set of first features in the first data 111 and/or combine one or more first features into a set of second features, and generate the second data 112 on the basis of the reduced set of first features and/or the set of second features. The dimensionality of the first data 111 can thereby be reduced while retaining relevant information. In this exemplary embodiment, the dimensionality reduction process is, or uses, principal component analysis (PCA) purely by way of example, wherein alternatively or additionally can also be applied factor analysis, canonical correlation analysis, correspondence analysis, multidimensional scaling, random forest, or the like, or a combination thereof.

In some exemplary embodiments, the dimensionality reduction process can identify and modify a number of amplitude-related signal features and/or phase-related signal features in the first data 111, and generate the second data 112 on the basis thereof. For example, the second data 112 can comprise information on the first data, selected from: mean, variance, kurtosis, skewness, maximum value, minimum value, coefficient of variation, range, value of the arg max operator, standard deviation, peak location, peak magnitude, peak phase, peak shape, peak width, zero crossing rate, FFT maximum amplitude,

FFT maximum frequency, entropy of the spectral power density, spectral flatness, autocorrelation width, autocorrelation peaks, sine frequency, amplitude, sine R\hat{ }2, main velocity, main velocity magnitude, velocity center of gravity, velocity curvature, velocity skewness, time difference of arrival, phase difference of arrival, and angle of arrival.

The at least one radar sensor 200 can be any type of radio-based sensor that emits signals and receives the echoes reflected from objects as corresponding signals, example, localizes and, for detects, etc. objects therefrom. For example, the at least one radar sensor 200 can be an ultra-wideband (UWB) sensor configured for radar operation. The at least one radar sensor 200 can also be configured to detect vital signs, for instance breathing etc., of vehicle occupants. The radar sensor can be arranged in the vehicle interior. A plurality of radar sensors for monitoring the vehicle interior can also be provided.

FIG. 2 illustrates in a schematic side view a vehicle 1 that has the above-described device 100 for providing data for monitoring a vehicle interior or has a system for monitoring a vehicle interior which comprises the device 100 and the above-mentioned control means 400.

As described above, the device 100 is coupled to the at least one radar sensor 200, which is configured and arranged to detect or to monitor the vehicle interior of the vehicle 1. As mentioned above, a plurality of radar sensors 200 can also be provided, even though FIG. 2 shows only one by way of example. Via the at least one data interface 110, the device 100 obtains the first data 100, which, for example, represents the raw data from the at least one radar sensor 200. Purely by way of example, the at least one radar sensor 200 is an ultra-wideband (UWB) sensor that operates in radar mode. In addition, the device 100 is coupled by the at least one data interface 110 to the above-mentioned vehicle bus 300. The control means 400 is in turn coupled to the vehicle bus 300.

The device 100 described herein is configured to condition the first data 111, which is obtained from the at least one radar sensor 200, in such a way that although the second data 112, which is then transferred via the vehicle bus 300, contains information relevant to the monitoring of the vehicle interior, the data volume of the second data 112 is reduced compared with the first data 111, i.e. the raw data from the at least one radar sensor 200. This allows the bus load on the vehicle bus 300 to be minimized while achieving precise detection and/or monitoring of the vehicle interior.

The control means 400 is configured to receive the second data 112 via the vehicle bus 300, and to perform on the basis of the second data 112 a monitoring process for the vehicle interior. The control means 400 can be configured, for example, to detect objects, people or vehicle occupants, their vital signs, etc., i.e. to monitor the vehicle interior, and to trigger, control etc. on the basis of the analysis of the second data 112 a relevant vehicle function, wherein the vehicle function can comprise, for instance, an alarm system of the vehicle 1, the air conditioning, access to the vehicle, the door actuation, or the like. For example, the control means 400 can be a control unit of the vehicle and accordingly have a vehicle bus module, for instance a CAN module, a LIN module, or the like, in order to obtain or receive the second data 112. In addition, the control means 400 can have processing logic, a processor, or the like, and be configured to receive the second data 112 and evaluate it for the purpose of monitoring the vehicle interior. The control means 400 can have for the purpose of performing the monitoring process a classifier, machine learning algorithm, or the like, selected from: support vector machine, SVM, perceptron, multi-layer perceptron, MLP, and convolutional neural network. For example, the classifier can be trained on the basis of real or simulated training data that is at least similar to the second data 112, for instance has a similar or identical data structure, similar or identical features or feature set, etc.

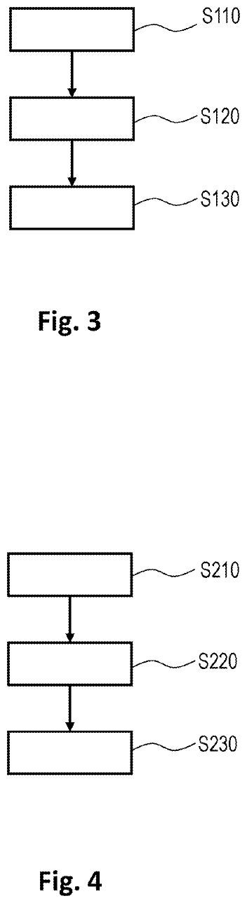

FIG. 3 illustrates in a flow diagram a method for providing data for monitoring a vehicle interior. The method can be executed by the above-described device 100, for example. The method comprises obtaining (S110) first data 111, which represents, contains, etc. raw data from a radar sensor 200, which raw data relates to the vehicle interior and has a first dimensionality. The method further comprises performing S120 a dimensionality reduction process on the first data 111 in order to generate second data 112, which has a second dimensionality, which is lower in comparison with the first data 111. In addition, the method comprises providing S130 the second data 112 for a vehicle bus 300.

FIG. 4 illustrates in a flow diagram a method for monitoring a vehicle interior. The method can be executed, for example, by the above-described system having the device 100 and the control means 400. The method comprises providing S210 second data S112 in accordance with the above-described method (cf. FIG. 3). In addition, the method comprises receiving S220 the second data 112 via the vehicle bus 300. Furthermore, the method comprises performing S230 a monitoring process for the vehicle interior on the basis of the second data 112. The method optionally further comprises providing third data for controlling at least one vehicle function based on the monitoring process.

In addition, a computer program can be provided that comprises commands which, on execution of the program by a processor, for example the processing logic 120 of the device and/or the processing logic, the processor, or the like of the control means 400, cause this to execute one r more of the above-described methods and/or implement the device 100 or the above-described system.

### LIST OF REFERENCE SIGNS

1 vehicle
100 device
110 data interface(s)
120 processing logic (e.g. processor)
200 radar sensor(s)
300 vehicle bus
400 control means

1.-15. (canceled)

16. A method for providing data for monitoring a vehicle interior, comprising:
obtaining first data, which represents raw data from a radar sensor, the raw data relating to the vehicle interior and having a first dimensionality;
performing a dimensionality reduction process on the first data in order to generate second data, which has a second dimensionality, which is lower in comparison with the first data; and
providing the second data for a vehicle bus.

17. The method as claimed in claim 16, wherein the dimensionality reduction process reduces a set of first features in the first data and generates the second data based at least in part on the reduced set of first features.

18. The method as claimed in claim 16, wherein the dimensionality reduction process combines one or more first features into a set of second features, and generates the second data based at least in part on the set of second features.

19. The method as claimed in claim 18, wherein the dimensionality reduction process reduces a set of first features in the first data and generates the second data based at least in part on the reduced set of first features.

20. The method as claimed in claim 16, wherein the dimensionality reduction process identifies and modifies a number of amplitude-related signal features in the first data, and generates the second data based at least in part on the modified amplitude-related signal features.

21. The method as claimed in claim 16, wherein the dimensionality reduction process identifies and modifies a number of phase-related signal features in the first data, and generates the second data based at least in part on the modified phase-related signal features.

22. The method as claimed in claim 21, wherein the dimensionality reduction process identifies and modifies a number of amplitude-related signal features in the first data, and generates the second data based at least in part on the modified amplitude-related signal features.

23. The method as claimed in claim 16, wherein the dimensionality reduction process comprises principal component analysis.

24. The method as claimed in claim 16, wherein the second data comprises information on the first data that is selected from a group consisting of one or more of: mean, variance, kurtosis, skewness, maximum value, minimum value, coefficient of variation, range, value of an arg max operator, standard deviation, peak location, peak magnitude, peak phase, peak shape, peak width, zero crossing rate, FFT maximum amplitude, FFT maximum frequency, entropy of a spectral power density, spectral flatness, autocorrelation width, autocorrelation peaks, sine frequency, sine amplitude, sine R\hat{ }2, main velocity, main velocity magnitude, velocity center of gravity, velocity curvature, velocity skewness, time difference of arrival, phase difference of arrival, and angle of arrival.

25. A method for monitoring a vehicle interior, comprising:
providing second data by performing the method of claim 16;
receiving the second data via the vehicle bus; and
performing a monitoring process for the vehicle interior based at least in part on second data.

26. The method as claimed in claim 25, wherein the monitoring process applies a classifier, which is trained based at least in part on training data that has the second dimensionality.

27. The method as claimed in claim 26, wherein the classifier is trained to detect features in the vehicle interior based at least in part on the second data, wherein the features comprise at least one of the group consisting of: objects in the vehicle interior, people in the vehicle interior, attributes relating to objects in the vehicle interior or attributes relating to people in the vehicle interior.

28. The method as claimed in claim 25, further comprising:
providing third data for controlling at least one vehicle function based at least in part on the monitoring process.

29. A device for providing data for monitoring a vehicle interior, comprising:
at least one data interface configured to obtain first data, wherein the first data represents raw data from a radar sensor, the raw data relating to the vehicle interior and having a first dimensionality; and
processing logic configured to perform a dimensionality reduction process on the first data in order to generate second data having a second dimensionality, which is lower in comparison with the first data,
wherein the at least one data interface is additionally configured to provide the second data for a vehicle bus.

30. A system for monitoring a vehicle interior, having:
a device as claimed in claim 29, and
a control means configured to receive the second data via the vehicle bus, and to perform a monitoring process for the vehicle interior based at least in part on the second data.

31. The system as claimed in claim 30, wherein the control means includes at least one classifier selected from a group consisting of: a support vector machine, a perceptron, a multi-layer perceptron, and a convolutional neural network.

32. The system as claimed in claim 30, wherein the control means is further configured to control at least one vehicle function based at least in part on the monitoring process.

33. A vehicle having a system as claimed in claim 30.

34. A vehicle having a device as claimed in claim 29.

35. A non-transitory computer readable medium having a computer program comprising commands which, on execution of the program by a processor, cause execution of the method as claimed in claim 16.
